(19) United States
(12) Patent Application Publication
(10) Pub. No.: US 2021/0244237 A1
(43) Pub. Date: Aug. 12, 2021

(54) Barton Blocks, Modular, - Admiral - Kitch Island Cutting Board Station

(71) Applicant: John McClain Barton, Millbrae, CA (US)

(72) Inventor: John McClain Barton, Millbrae, CA (US)

(73) Assignee: John McClain Barton, San Carlos, CA (US)

(21) Appl. No.: 17/073,276

(22) Filed: Oct. 16, 2020

(51) Int. Cl. A47J 47/00; A47B 33/00

(52) U.S. Cl. CPC A47J 47/005; A47B 2220/0077; A47B 33/00

(57) ABSTRACT

Large, kitchen island cutting board on locking wheels, that provides a safe and proficient food preparation working device for cooks of all skill levels. This invention incorporates a base unit that said device and components reside in and on as described herein. Cutting board height of invention is adjustable, a stand and handle for said cutting board is attached. The cutting board has attached to it stainless-steel deep-dish food pans in folding brackets to hold food items to be prepared and or debris deposited into for disposal. A light fixture above cutting area for convenience and safety is attached to the base unit of the invention.

### BACKGROUND OF THE INVENTION

The inventor, John Barton, has over ten years experience in restaurant management and was a General Contractor. Most of his restaurant duties involved kitchen responsibilities such as creating safe and efficient environments for the people prepping and working with food and drink items. The inventor envisioned and built a movable, large, kitchen island cutting board that provides a safe and proficient food preparation working devise for cooks of all skill levels as represented herein. The usual table and or kitchen island cutting board offerings by manufacturers of these kind of devices, only offered a table on wheels with a butcher block or cutting board on top. Mr. Barton visualized much more and decided to construct his version of a cutting board on wheels. He started building from his imagination what it should consist of to exceed similar products available. He constructed a large cutting board as shown herein and built a table around it. He pursued his goal of an exceptional cutting board apparatus with copious experimentation, build and rebuild often, with two prototypes, to eventually have the modular structure as described herein. Also, all members of his family have extensive experience in food service. Each of them is an experienced cook, familiar with fast-paced, busy kitchens. Consequently, they would act as knowledgeable testers. Their feedback on how this product functions in real-world situations made the suggestions they provided, valuable information regarding ways to improve it. If warranted, Mr. Barton would adjust the station based on testing.

### BRIEF SUMMARY OF THE INVENTION

The invention as described herein is modular and may be configured and adapted to the requests of patrons. The modular design makes this invention practical for shipping. All the modular parts that form the completed structure are less than 4 feet in length. Consequently, shipping or traveling with this invention is much more convenient. The invention has features that are not seen or available in the marketplace for this kind of equipment. Such as but not inclusive: Adjustability of cutting board height, lights above cutting area for convenience and safety and folding, removable brackets that hold large food service deep food pans. The deep food pans may be used to hold food items to be cut and prepped and or to receive cuttings of food items for disposal. It is a benefit in kitchens of all sizes. It provides extra food preparation, movable counter space and storage for large kitchen. It can also be used as a complete and compact workspace in economical kitchens in small homes and apartments. The inventor has worked on this prototype Invention for over two years with great attention to making it safe, efficient and stylish. He intends to produce this product and market it in many ways. He would very much like to protect it, if possible, with a U.S.P.T.O. patent for the many aspects of this invention. These drawings and explanations pertain to the full-size prototype model and variations of it to follow in the future. He plans to produce for sale, this model and other cutting stations using this BARTON BLOCKS, -ADMIRAL-, MODULAR KITCHEN ISLAND CUTTING BOARD STATION as the example and model. From this model he would like to produce it in assorted sizes, configurations, and titles. It is hoped by John Barton that a Provisional and eventual Utility patent, if granted, will cover these new models which will be very similar, as well. Over the years the inventor has made many cutting boards for family and friends, but never did he put in the energy and creative efforts as he has done with this design. This cutting station has far surpassed his initial concepts and he is totally convinced that he has a superior product to anything in the marketplace thereof.

Mr. Barton has 31 drawings on 11 pages and 9 photos on 5 pages in this application that he feels will depict his invention well. The modular unit drawn with all parts together and then detail drawings of the individual parts or features that make up the whole. He hopes this approach is acceptable.

Thank you for your kind attention, John M. Barton.

### BRIEF DESCRIPTION OF THE DRAWINGS

FIG. 1—Is a perspective view of the invention. It is a synopsis of the modular design and features thereof.

FIG. 2—Is a perspective view of the invention completely assembled. Photos 1, 2 and 3, are photos of the inventor's prototype that are very similar to these drawings and could be helpful to see the real thing thereof.

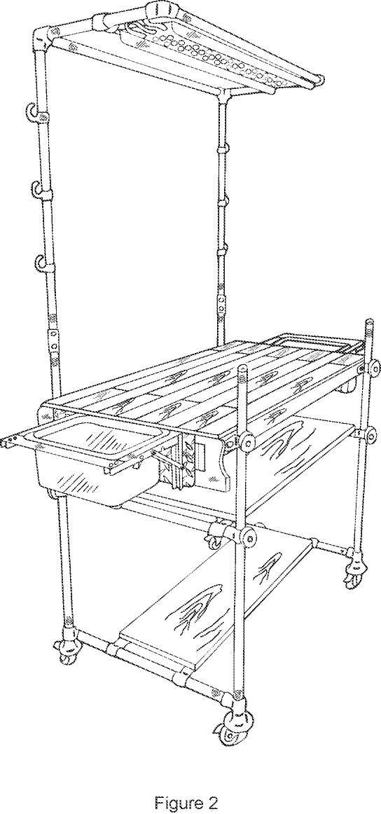

FIG. 3—Is a perspective view of how the modular structure is put together thereof.

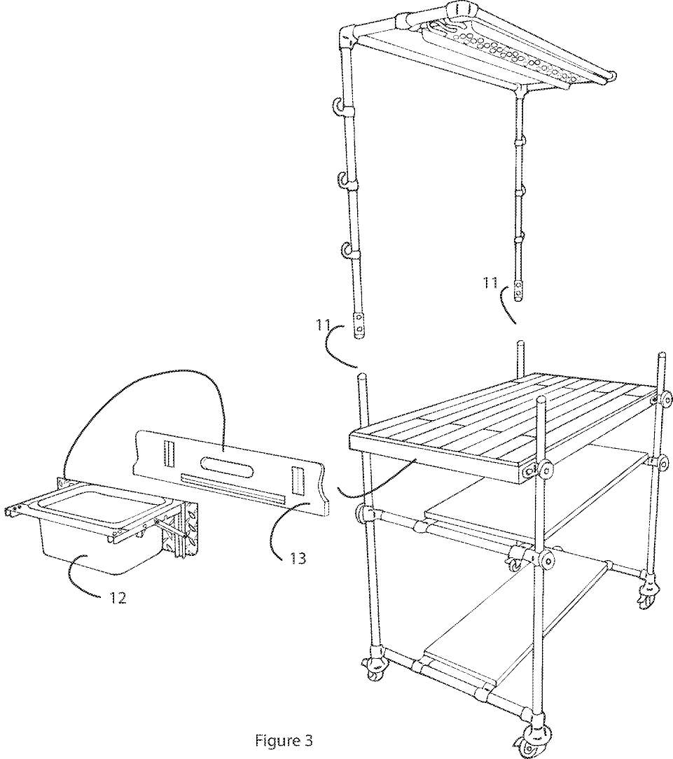

FIG. 4—Shows different views of the base unit thereof.

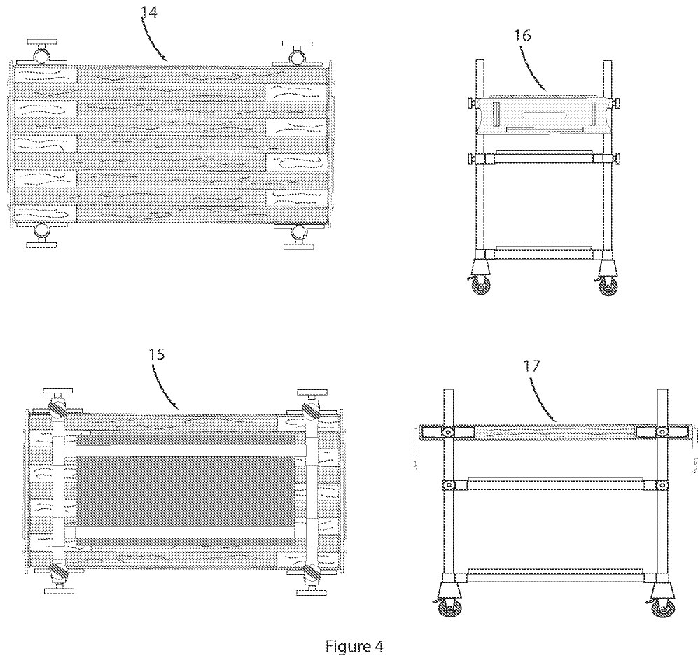

FIG. 5—Illustrates the dimensions of the views of the base unit for reference thereof.

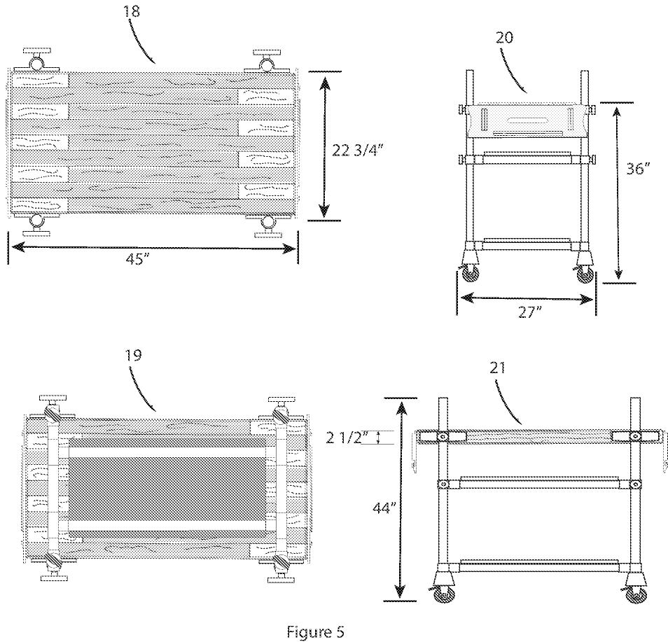

FIG. 6—These drawings show different configurations of the stand for the base unit thereof.

FIG. 7—Are views and different configurations of the stand for the Platform. The stand has rubber or vinyl padding on the bottom edges thereof.

FIG. 8—Are drawings of the brackets that hold the deep food pans thereof.

FIG. 9—Is a top perspective view of bracket and deep food pan butted up against the 45-degree bevel edge of the platform thereof.

FIG. 10—These drawings show top view, birds eye view looking down and bottom view looking up from the platform to the light system thereof.

FIG. 11—These drawings are details of the platform and the 45-degree bevel on top and bottom edge of platform thereof.

Photo 1—Is a perspective view of Barton Blocks, Admiral thereof.

Photo 2—Is a front perspective view of Barton Blocks, Admiral. This photo shows the brackets in the folded down position thereof.

Photo 3—Is a front perspective view of Barton Blocks, Admiral. This photo shows the brackets in the up locked position with the deep food pans thereof.

Photo 4—These photos show brackets from lower folded position and swing up to locked position and then a deep food pan in place thereof.

Photo 5—Top photo deep food pan in place. Lower photo close-up of 45-degree bevel thereof.

### DESCRIPTION OF NUMERICAL FEATURES IN THE DRAWINGS

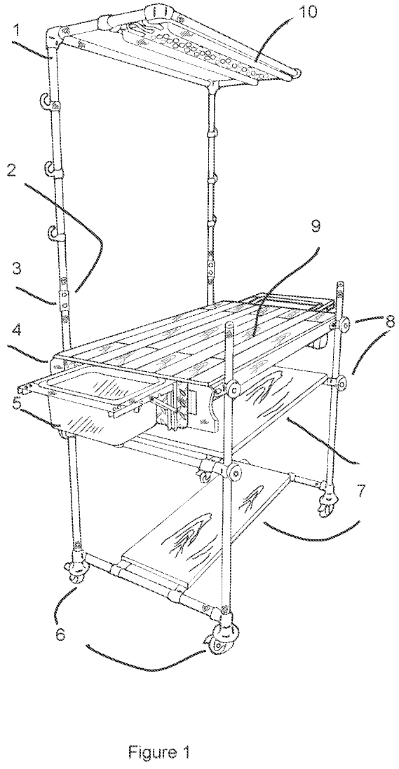

In FIG. 1 the drawing shows the complete modular structure. A base unit, a stand and handle, stainless steel large deep food pans in brackets for food items and debris disposal and light fixture structure. These modular add-on items are shown and described in drawings included in this application herein and thereof.

1—Framework of invention. The framework and fittings of structure is galvanized steel. The framework of structure is ¾-inch structural steel pipe thereof.

2—Bottom of Light fixture. Light fixture attached with structural steel set screws thereof.

3—Base unit is the complete structure from light fixture attachment down. Each side of base unit is mirror image of each other. Each end of base unit is mirror image of each other thereof

4—Each side of platform has a ¼-inch thick×8-inches H×24-inches L, 6061 aluminum plate securely attached thereof.

5—The food pan and brackets are removable. The deep food pans and brackets are stainless-steel. The diamond plate is aluminum thereof

6—Four wheels for movement. All 4 wheels are lockable thereof.

7—The middle and bottom shelves are clear straight grain white pine wood, mounted on structure. Drawers or other useful items may be easily installed on these surfaces. The middle shelf is adjustable in height thereof.

8—There are four knobs for the platform, 2 on front and 2 on back. There are Four knobs for the middle shelf, 2 on front and 2 on back. These knobs may be loosened, and platform or shelf may be adjusted in height individually as desired and then retightened to stay in place thereof.

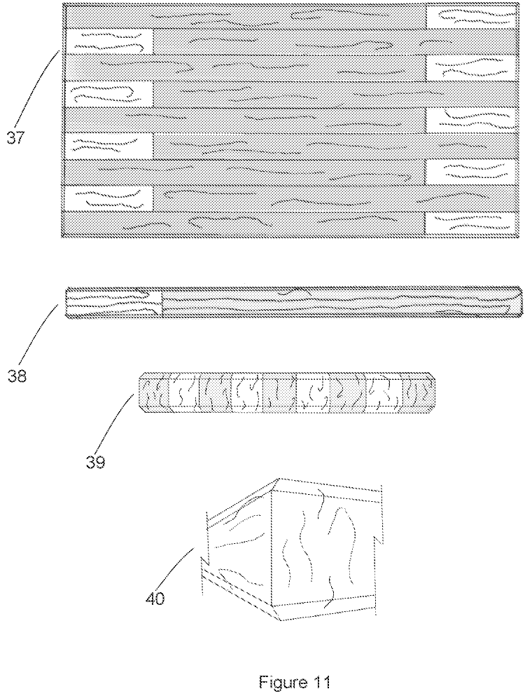

9—The top cutting board or platform is; 2½-inches thick×22½-inches W×43½ inches Length. The woods are made of clear straight grain red oak and poplar, finished and smooth with food grade finishes. The top cutting board or referred to as platform, is mirror image, top and bottom, End and end, and side and side. This facilitates the ability for the platform to be flipped over for a new surface if desired. FIG. 11 are detailed drawings and descriptions of cutting board top or platform. Wood grain patterns vary from one board to another board. No two are perfectly alike. In this invention application and any other uses, the grain patterns are not considered to be identically the same in mirror image. In mirror image the woods are to be as described and the grain patterns are similar thereof.

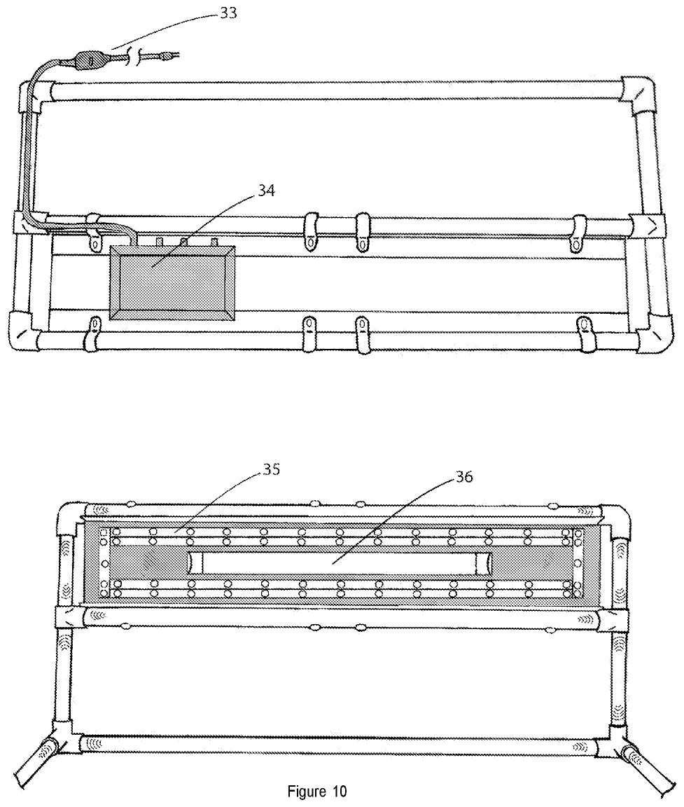

10—A full drawing description of the light fixture is included in FIG. 10 thereof.

11—Is the light fixture structure. It has connector fittings at the bottom of the pipes which are placed over and on the base unit pipes. Then the connectors are secured in place by heavy duty set screws. This is a modular add on and is very useful. A full drawing description of the light fixture is included in FIG. 10 thereof

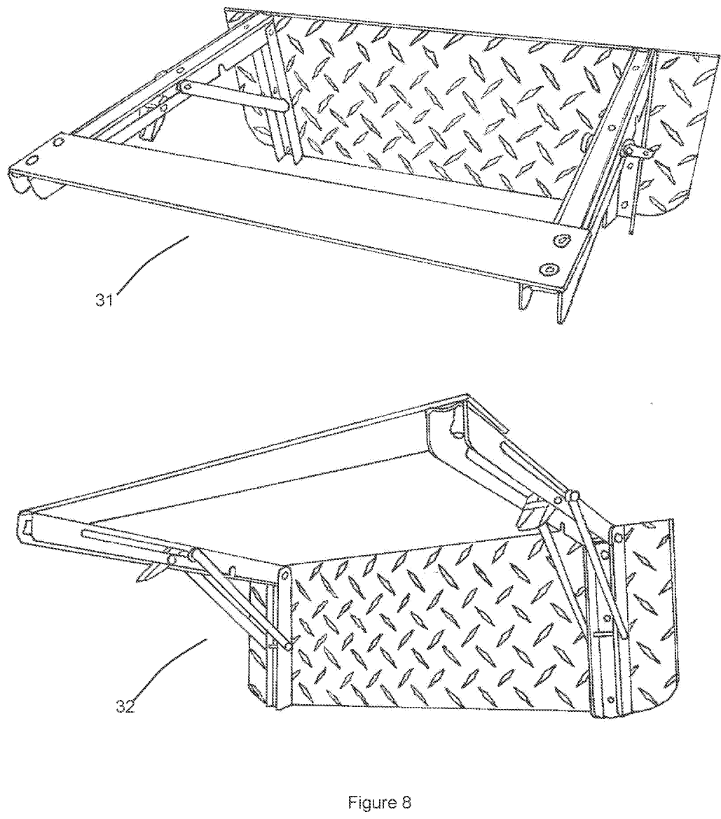

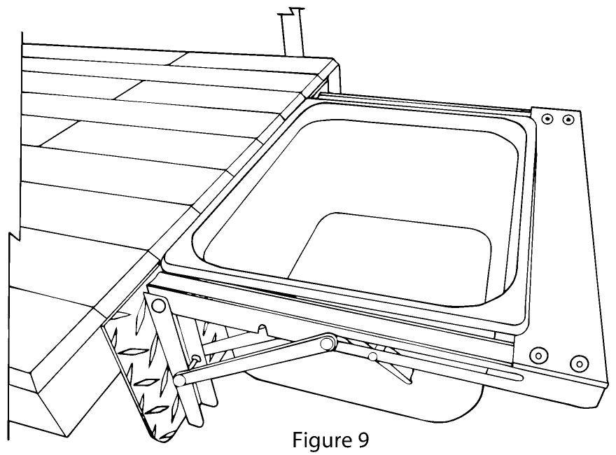

12—Is the bracket and deep food pan that fits into the stand. FIGS. 8 and 9 are detail drawings of the brackets thereof.

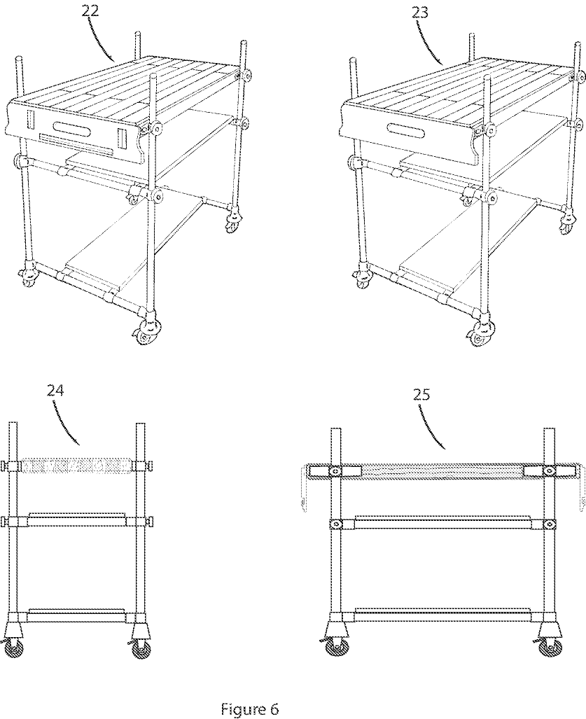

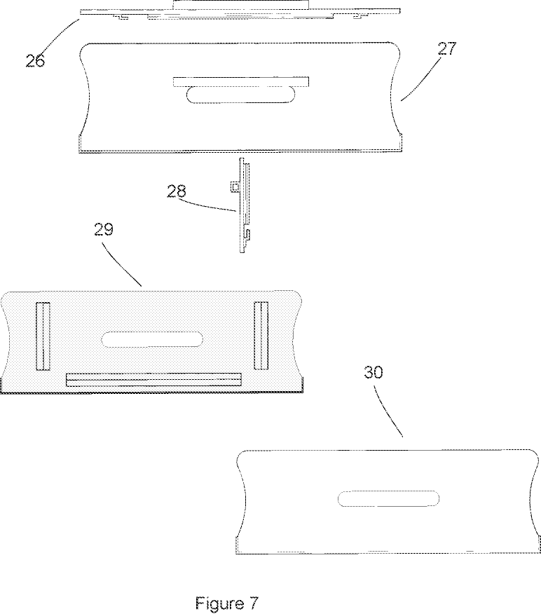

13—Stand for the platform. FIG. 6 and FIG. 7 are detail drawings and descriptions of the stand thereof

14—Is a top plan view of base unit. The top is mirror image; to reverse Side or bottom. Side to side are mirror image of each other. End to end are mirror image of each other. The drawings in FIG. 11 show this feature in detail thereof.

15—Is a bottom plan view of base unit thereof.

16—Is an end elevational view of base unit. The end view is a mirror image of the other end thereof.

17—Is a side elevational view of base unit. The side view is a mirror image the other side thereof.

18—Is a top plan view of base unit. Length and width of platform thereof.

19—Is a bottom plan view of base unit thereof.

20—Is an end elevational view of base unit. Width of end view. Height of end view is the distance from top of platform to floor thereof.

21—Is a side elevational view of base unit. Height of side view thereof.

22—Is a top perspective view showing stand on one end of the base unit with the z bar metal attached for which the bracket assembly fits into thereof.

23—Is a top perspective view showing stand on one end of the base unit with no z bar strips thereof.

24—Is an end elevational view of the base unit with no stand thereof.

25—Is a side elevational view of the base unit showing a profile of the stands thereof.

26—Is a top plan view of platform stand thereof.

27—Is a back elevational view of platform stand thereof.

28—Is a side elevational view of platform stand thereof.

29—Is a front elevational view of platform stand thereof.

30—Is a front elevational view of platform stand with no z bar metal thereof.

31—Is a top perspective view of bracket thereof.

32—Is a bottom perspective view of bracket thereof.

33—Is the power source for lighting. Is a 25-ft 12-gauge heavy duty cord. Rainproof rated for indoor and outdoor use. Triple tap 3 outlet female connector allows for multiple usage. Construction and industrial grade. GFCI safety assurance, OSHA compliant, highly visible “safety” yellow color. LED power on indicator. 15-amp, 125 volts rated thereof.

34—SOCKiTBOX—The original weatherproof connection box. Indoor & outdoor electrical power cord enclosure for timers, extension cables, transformers, power strips, lights, tools & more thereof.

35—LED light strips. Water resistant, remote control, dimmable, multicolor thereof.

36—LED bright white light, on off, remote control fixture thereof.

37—Is top elevational view of platform. The top and bottom of the platform are mirror images of each other thereof.

38—Is side elevational view of platform. Each side is mirror image of the other thereof.

39—Is end elevational view of platform. Each end is mirror image of the other thereof.

40—Is a perspective side and end view of the bevel edge, top edge and bottom edge of platform thereof.

### DETAILED DESCRIPTION OF THE INVENTION

The platform is adjustable up or down based on the height of the individual standing at the cutting surface. Whether a user is tall or short, the station is customizable to help accommodate them. This ensures the person cutting at the board is positioned comfortably and at a safer cutting distance from the surface thereof. [0062] The height of this prototype cutting surface or platform is set at 36-inches which is standard for cabinet countertops. However, the Barton Block Admiral cutting surface may be raised or lowered by 6 inches using adjuster knobs that are mounted on the face and back side of the cutting board thereof.

There are four knobs for the platform, 2 on front and 2 on back. There are four knobs for the middle shelf, 2 on front and 2 on back. These knobs may be loosened, and platform or shelf may be adjusted in height or removed individually as desired then retightened to stay in place thereof.

The platform may be removed from the base unit. The stand on each end of the platform is used for the purpose of support if the platform were to be removed from the base unit and set down somewhere. The stands are securely attached to the end edges of the platform. After removing the light structure, large stainless-steel food service deep food pans and brackets, the platform may be raised up and from the base unit. Then the platform could be used on a countertop or table as a food server for hors d'oeuvres or other food items or used as a regular large cutting board thereof.

When deep food pans and brackets are removed from the stand, a 1-inch×8-inch cutout slot is revealed in the middle of the stand. This slot is a comfortable hand hold to lift the platform from the base unit or to hold onto while adjusting height of platform thereof.

The bracket mechanisms on the cutting station are made and mounted in such a way as to hold large stainless-steel food service deep food pan receptacles, and or othervesels in place. At each end of the cutting surface are folding brackets which, when raised and in locked position, hold the deep food pans. FIGS. 8 and 9 are detail drawings of the brackets. The deep food pans are versatile and easy to use. Food debris and cuttings may be scraped or deposited in a deep food pan and disposed of later. One of the deep food pans could be used for this purpose and the other deep food pan could hold the finished cut product or items ready to be cut thereof.

The folding brackets are stainless-steel, maximum load: 330-lb. These brackets are custom fitted to hold large stainless-steel food pans or may be adapted to other kinds of vessels. The brackets and pans are removable and mount to the ends of the cutting platform aluminum stand. The sturdy design creates a safe way to organize food and scraps efficiently and with speed thereof.

The brackets are designed to have the deep food pans butt up against the cutting platform, right below the bottom of the 45-degree bevel on the top cutting board edge. This helps to ensure all dropping are deposited into the pans perfectly thereof.

The edges, both top and bottom, of the platform surface have a 45-degree straight bevel edge which is a style feature, but also specially designed to help debris pieces land directly into the deep food pan receptacles at each end thereof.

What is claimed is:

1) A large kitchen island cutting board or also referred to as cutting station with modular features and attachments that may be configured in many ways to suit ones needs, all of the components and attachments as described in the specifications and claims work together to form a strong safe working tool for food preparation and or this unit may be adapted to work for other constructive activities, comprised: a base unit, that form the structure, shape and uses of said invention, comprising: ¾ inch structural galvanized pipe or the like and fittings with customized high quality hardwoods or the like for shelving and cutting board or referred to as platform to work on, said shelves with knobs to adjust height vertically or downward in the same fashion, a said large platform, with knobs to adjust height vertically or downward in the same fashion, stands attached to said platform side or end or other suitable placement on platform for hand holds while moving or adjusting said platform, folding custom sized brackets on said stands that attach to said stands and back side or other placements on said platform, to hold deep stainless steel food containers or the like, comprising: ¾ inch structural galvanized pipe and connecting attachments, which attach to back side or other convenient locations of said base unit for lights, shelving or other features and fixtures to reside on, an electrical system comprising: to power lights above cutting surface of said invention platform, for convenience and safety and power strip, for plug in devices.

2) A said base unit according to claim 1, comprising: framework made up of ¾ inch structural galvanized pipe and fittings that form the structure, shape and uses of said invention, the said base unit is mounted on heavy duty locking wheels for mobility or holding steadfast in place,

3) A said platform and shelves according to claim 1, comprising: four threaded fittings attached to said platform and said shelves to receive threaded knobs, one on each long side or other locations as needed, which allow said platform or said shelves to slide up or down by turning customized knobs that are attached to the said fittings, clockwise to tighten, counterclockwise to loosen to accommodate height adjustment, the middle shelf mounted directly below said platform comprising: is mounted on ¾ inch structural galvanized pipe and said fittings in order to slide up or down by turning said customized knobs that are attached to said fittings on said platform and said shelves clockwise to tighten, counterclockwise to loosen to accommodate height adjustment in accordance of space needed if necessary for said platform clearance, said customized knobs are made up of 2.38 inch snap lock fluted knobs, hex hole to accept ½ inch nuts and bolts, black, with grade 8 fine hex cap screws, ½ inch 20 thread×1 inch,

4) The said base unit shelves, according to claim 3, comprising: said shelves that are securely attached to metal pipes running laterally to said base and the shelve pipes are connected to base unit cross members to vertical pipes by specially designed connector fittings which help strengthen and hold the said base unit together, and are adjustable, affords easy assembly and disassembly for initial set up or packing for shipping.

5) The large said cutting board or said platform according to claim 1, comprising: meticulously and carefully selected woods for quality in beauty and functionality, such as, free of knot holes, warpage, cupping or other compromising and undesirable features, that are clear straight grain or swirl patters and other features as the wood worker or customer desires comprised of: maple, walnut, cherry, oak, poplar, or the like of hard woods or other kinds of quality woods that are applicable for cutting board use, finished and smooth with food grade finishes, the top of said cutting board, is mirror image, top and bottom, end and end, and side and side, this facilitates the ability for the said platform to be rotated 180 degrees for a new surface if desired, the edges of said platform have connector hardware that facilitates pipes to slide up or down for desired height, both top and bottom surfaces of said platform are sanded smooth and finished identically which makes them mirror image, in the term mirror image, wood grain patterns vary from one board to another board, no two are perfectly alike, in this invention application and any other uses, the said grain patterns are not considered to be identically alike but similar and standard for the kind of wood it is,

6) The edges of said platform, according to claim 1 comprising: both top and bottom, of the said platform surfaces have a 45-degree straight bevel edge completely around both top and bottom edges which is a style feature, but also specially designed to help debris of finished cutting or other items from the cutting or preparation activities of food items or other constructive activities or the like, to be scraped or moved across platform and land directly into the deep food pan or other receptacles at each end or other placements of the collection receptacles of said platform,

7) The height of said cutting surface or said platform, according to claim 1, comprising: is set at 36 inches which is standard for cabinet countertops, but may be raised or lowered as desired and held in place by the function of said knobs.

8) The set of two platform stands, according to claim 1 comprising: mounted on said platform fore and aft short end faces or other suitable location according to claim 1, comprising: said stand connected to said platform may be removed from the base unit, the said stands on each end of the platform is used for the purpose of support, the wood or metal of said stands extent downward 90 degrees from said platform large surface by several inches, providing stability and height above surface the said platform is placed upon, if the said platform were to be removed from the said base unit and set down somewhere, the said stands are smooth surfaces for safe handling or hand hold slots cut out of stand or some other method or device for handling convenience, the said stands are securely attached to the said platform end short faces, after removing the light structure, large stainless-steel food service deep food pans and brackets, the said platform may be raised up and from the base unit, then the said platform could be used on a countertop or table and the like as a food server for hors d'oeuvres or other food items or used as a regular large cutting board and or other projects requiring a large flat surface to work on.

9) The said stands have attached to them, according to claim 1, said folding brackets, comprising: said brackets are custom fitted to support stainless-steel deep-dish food pans or other kinds of vessel inserts to hold food items to be prepared and or debris deposited into for waste disposal, or be used for other needs such as placing items in a stable environment, the two said brackets at each end of said platform are connected by an aluminum bar or similar device that make them work as one unit to which said deep dish pans reside in, when said bracket mechanisms are in the horizontal or 90 degree position, the said bracket mechanisms when not holding said deep dish food pans in the horizontal position may be articulated to a down or 0 degree position resting vertically against said platform stand, other similar brackets or holding devises of said bracket mechanisms.

10) The power source for lighting, according to claim 1, comprising: a 25-ft 12-gauge heavy duty power cord or the like, rainproof rated for indoor and outdoor use, GFCI safety assurance, osha compliant 125 volts rated or the like, or battery powered and the like of a safe power system that resides above the said platform surface for adequate or abundant visibility in food preparation or other uses of said platform top

11) The light fixture structure according to claim 1, comprising: has connector fittings, at the bottom of the pipes of said light fixture which are placed onto and over the said base unit rear pipes or other connecting areas of said platform or said base unit, then the connections are secured in place by heavy duty set screws or the like, the lights are attached to an aluminum plate with aluminum 90-degree angle for reinforcement of the metal-plate or other acceptable surface to accommodate attaching electrical apparatus onto, light for the said platform is provided by, LED light strips, water resistant, remote control, dimmable, multicolor and LED bright white light or other suitable light source, which is water resistant or water proof, weatherproof connection boxes or the like, house all electrical plug-ins, Indoor & outdoor electrical power cord enclosure for timers, extension cables, transformers, power strips, lights, tools and the like, the said light system located above the said platform is for cutting area of said invention to help improve visibility and make a safer work area from sharp edges and the like.
